(19) United States
(12) Patent Application Publication
(10) Pub. No.: US 2026/0094888 A1
(43) Pub. Date: Apr. 2, 2026

(54) THERMAL RUNAWAY EVENT DETECTION SYSTEM FOR ENHANCED SAFETY INTEGRITY IN BATTERY SYSTEMS

(71) Applicant: Rivian IP Holdings, LLC, Irvine, CA (US)

(72) Inventors: Tejas Abhay CHAFEKAR, Edwards, IL (US); Baojin WANG, San Marcos, CA (US); Long Phi HUYNH, Brea, CA (US)

(21) Appl. No.: 19/255,739

(22) Filed: Jun. 30, 2025

Related U.S. Application Data
(60) Provisional application No. 63/701,017, filed on Sep. 30, 2024.

(51) Int. Cl. H01M 10/48; B60L 58/10; G08B 21/18; H01M 10/42

(52) U.S. Cl. CPC H01M 10/486; B60L 58/10; G08B 21/185; H01M 10/425; H01M 2010/4271; H01M 2010/4278; H01M 2200/10; H01M 2200/20; H01M 2220/20

(57) ABSTRACT

Aspects of the subject disclosure relate to thermal runaway event detection system for enhanced safety integrity in battery systems. The system includes a first electronic control unit (ECU), a second ECU, a sensor, and a monitoring circuit configured to receive sensor data from the sensor and pass the sensor data to the first ECU and the second ECU. The second ECU is configured to receive the sensor data from the monitoring circuit, determine whether the sensor data indicates an occurrence of a thermal runaway event associated with a battery of a vehicle, in which the second ECU detects the thermal runaway event independent of the first ECU. The second ECU can generate an alert notification to a user of the vehicle based on a determination that the sensor data indicates an occurrence of a thermal runaway event to cause a remedial action associated with the thermal runaway event.

### CROSS-REFERENCE TO RELATED APPLICATION(S)

This application claims the benefit of U.S. Provisional Application Ser. No. 63/701,017, entitled “THERMAL RUNAWAY EVENT DETECTION SYSTEM FOR ENHANCED SAFETY INTEGRITY IN BATTERY SYSTEMS,” and filed on Sep. 30, 2024, the disclosure of which is expressly incorporated by reference herein in its entirety.

### INTRODUCTION

Batteries are often used as a source of power, including as a source of power for electric vehicles that include wheels that are driven by an electric motor that receives power from the battery. This application is directed to thermal runaway event detection system for enhanced safety integrity in battery systems.

### SUMMARY

The subject technology relates to electric vehicles equipped with large batteries that power various high-load systems such as automotive electronics, motors, and HVAC units, which require substantial current. The subject technology can address safety concerns associated with advanced vehicle platforms, such as Level 3 autonomy, where driver intervention during critical events such as battery thermal runaway may not be assumed. In scenarios where a driver is unresponsive to a battery fire, the subject technology can escalate the Automotive Safety Integrity Level (ASIL) classification of thermal runaway detection to ASIL-D due to reduced controllability.

The subject technology can enhance safety by utilizing a layered approach. At the battery level, an ASIL-B classification addresses thermal runaway prevention through mechanisms like over-voltage and over-temperature protection. A separate ASIL-A classified electronic control unit (ECU) functions independently from a primary ECU in a battery management system (BMS) to detect thermal runaway events. Additionally, the subject technology includes a pressure sensor connected to a battery monitoring circuit, which can communicate with the BMS and the secondary ECU via a serial peripheral interface (SPI). The secondary ECU, operating in a listen-only mode, can receive pressure data and monitor for thermal runaway events independent of the primary ECU. Synchronization between the primary ECU and secondary ECU can facilitate correct pressure data interpretation. This independent ECU, not reliant on the primary ECU, can alert a driver of a vehicle based on a detection of a thermal runaway event, facilitating compliance with ASIL-D safety integrity standards and prompt remedial action on the vehicle.

This multi-tiered system can enhance vehicle safety by facilitating thermal runaway event detection and management, even in scenarios where the driver may not take timely control, providing increased reliability and robustness compared to other approaches.

In accordance with one or more aspects of the disclosure, a system is provided that includes a first electronic control unit (ECU); a second ECU; a sensor; and a battery monitoring circuit configured to receive sensor data from the sensor, and pass the sensor data to the first ECU and the second ECU, wherein the second ECU is configured to receive the sensor data from the battery monitoring circuit, determine whether the sensor data indicates an occurrence of a thermal runaway event associated with a battery of a vehicle, wherein the second ECU detects the thermal runaway event independent of the first ECU, and generate an alert notification to a user of the vehicle based on a determination that the sensor data indicates an occurrence of a thermal runaway event to cause a remedial action associated with the thermal runaway event.

In accordance with one or more aspects of the disclosure, a method includes receiving, by a secondary electronic control unit (ECU), sensor data from a battery monitoring circuit, processing pressure data in the sensor data based on an indication from a primary ECU; and generating an alert notification to a user of the vehicle based on a determination that the sensor data indicates an occurrence of a thermal runaway event associated with a battery of a vehicle to cause a remedial action associated with the thermal runaway event, wherein the second ECU detects the thermal runaway event independent of the primary ECU.

In accordance with one or more aspects of the disclosure, a vehicle including one or more sensors; a primary electronic control unit (ECU); a secondary ECU; and a battery monitoring circuit configured to receive, from the primary ECU, a command frame with a request to obtain sensor data from the one or more sensors, send, to the primary ECU, a response frame comprising sensor data in response to the command frame, and wherein the secondary ECU is configured to receive the sensor data from the battery monitoring circuit and the primary ECU on different communication links, determine that the sensor data is valid by performing one or more diagnostic checks on the sensor data, determine that the sensor data indicates an occurrence of a thermal runaway event associated with a battery of the vehicle, wherein the secondary ECU detects the thermal runaway event independent of the primary ECU, and generate an alert notification to a user of the vehicle to cause a remedial action associated with the thermal runaway event.

### BRIEF DESCRIPTION OF THE DRAWINGS

Certain features of the subject technology are set forth in the appended claims. However, for purpose of explanation, several embodiments of the subject technology are set forth in the following figures.

FIG. 1A and FIG. 1B illustrate schematic perspective side views of example implementations of a vehicle having a battery pack, in accordance with aspects of the present disclosure.

FIG. 2 illustrates a schematic perspective side view of another example implementation of a vehicle having a battery pack, in accordance with aspects of the present disclosure.

FIG. 3 illustrates a block diagram of an example vehicle for thermal runaway event detection in accordance with one or more implementations of the subject technology.

FIG. 4 illustrates a block diagram of an example thermal runaway event management system in accordance with one or more implementations of the subject technology.

FIG. 5 illustrates a block diagram of an example system flow for thermal runaway event detection in accordance with one or more implementations of the subject technology.

FIG. 6 illustrates a block diagram of another example thermal runaway event management system in accordance with one or more implementations of the subject technology.

FIG. 7 illustrates a block diagram of yet another example thermal runaway event management system in accordance with one or more implementations of the subject technology.

FIG. 8 illustrates a flow diagram of an example process for performing thermal runaway event detection in accordance with one or more implementations of the subject technology.

FIG. 9 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form to avoid obscuring the concepts of the subject technology.

In one or more implementations, electric vehicles utilize large batteries capable of driving various high-load applications, including automotive electronics, motors, drivetrains, heat pumps, and HVAC systems, which may require significant current. For applications requiring high Automotive Safety Integrity Level (ASIL), it is beneficial to facilitate robust and reliable data integrity and functional safety mechanisms.

In one or more implementations, the subject technology addresses challenges arising from advanced platforms such as Level 3 (L3) autonomy standards (e.g., hands-off autonomy or eyes-off autonomy), where a timely driver response may not be assumed. This scenario may increase the risk of a battery thermal runaway event, potentially leading to a vehicle fire. In one or more other implementations, a worst-case assumption may involve a driver of a vehicle being unresponsive to a battery fire, which elevates the ASIL classification of the thermal runaway event detection feature to the highest level of safety integrity (e.g., ASIL-D). This escalation may occur due to decreased controllability, as the driver may be unaware of the thermal runaway event and unable to take over vehicle control or pull over in time. As a result, the vehicle may automatically detect and prevent the occurrence of a battery thermal runaway event.

In one or more implementations, the subject technology may address the aforementioned challenges by decomposing the safety integrity into distinct components. In one or more implementations, the integrity level ASIL-B within the battery may be focused on preventing thermal runaway through safety mechanisms such as over-voltage and over-temperature protection systems. These mechanisms facilitate that the battery cells are maintained within healthy operating conditions.

In one or more other implementations, an integrity level ASIL-A may be applied to a secondary electronic control unit (ECU) that is independent from a primary ECU serving as a battery management system (BMS) in the vehicle. The secondary ECU may be responsible for detecting thermal runaway separately from the BMS and alerting the user to take control of the vehicle. The detection mechanism may be fully independent and not reliant on the primary ECU to ensure its functionality in the event the BMS becomes unavailable. The subject technology provides for a higher ASIL rating (e.g., ASIL-D) by utilizing independent electronic control units, enhancing the reliability and safety of the thermal runaway event detection process.

In one or more implementations, a pressure sensor may be connected to a battery monitoring integrated circuit (BMIC), which may be configured to communicate with the BMS over a serial peripheral interface (SPI) connection. The SPI connection can be routed to the secondary ECU, which is configured in a listen-only mode. This listen-only mode may allow the secondary ECU to listen for pressure data transmissions. The clock signal and chip select lines, controlled by the primary ECU, can be synchronized between the primary ECU and the secondary ECU to cause the secondary ECU to correctly interpret the pressure data transmissions while disregarding other sensor data transmissions (e.g., voltage, temperature) over the SPI connection.

The subject technology provides for a thermal runaway event management system having a first electronic control unit (ECU), a second ECU, a sensor, and a monitoring circuit configured to receive sensor data from the sensor and pass the sensor data to the first ECU and the second ECU. In some aspects, the second ECU is configured to receive the sensor data from the monitoring circuit, determine whether the sensor data indicates an occurrence of a thermal runaway event associated with a battery of a vehicle, in which the second ECU detects the thermal runaway event independent of the first ECU. The second ECU is further configured to generate an alert notification to a user of the vehicle based on a determination that the sensor data indicates an occurrence of a thermal runaway event to cause a remedial action associated with the thermal runaway event.

The subject technology differentiates itself from existing approaches by providing enhanced vehicle safety during a potential thermal runaway event. The subject technology facilitates safety even in cases where the user is unavailable, unresponsive, or unable to take control of the vehicle in a timely manner, thereby offering improved robustness over existing systems.

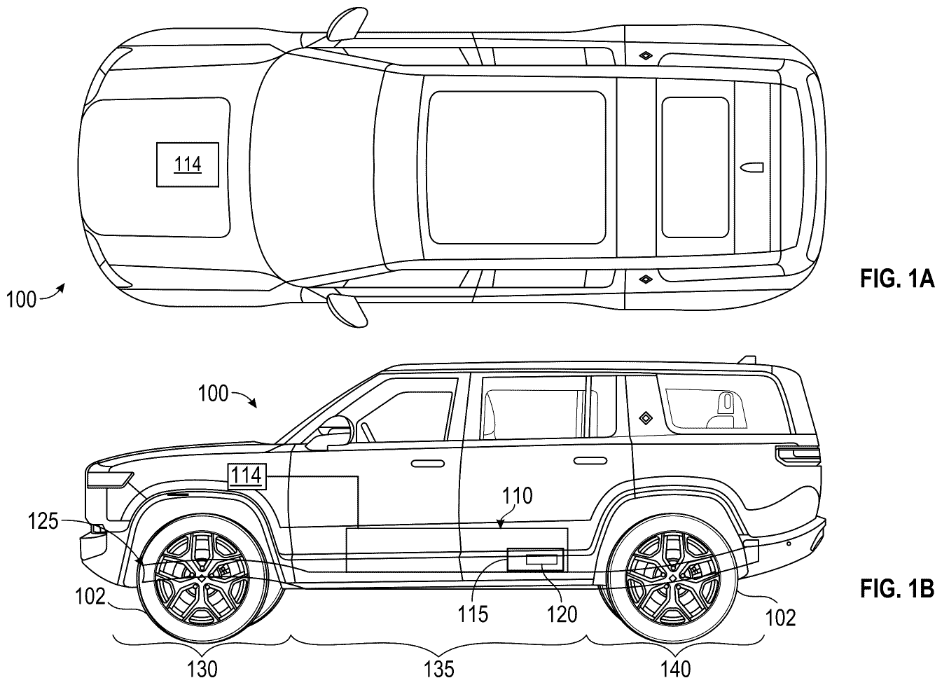

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive wheels 102 of the vehicle 100 using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid). In various implementations, the vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

For example, the battery cell 120 can be included in a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

In some implementations, the battery pack 110 can be combined with the battery management system (BMS) 114 and a battery monitoring circuit that can receive sensor data from one or more sensors and pass the sensor data to a first ECU in the BMS 114 and a second ECU separate from the first ECU. In some aspects, the second ECU can receive the sensor data from the monitoring circuit, determine whether the sensor data indicates an occurrence of a thermal runaway event associated with a battery of a vehicle, in which the second ECU detects the thermal runaway event independent of the first ECU. The second ECU is further configured to generate an alert notification to a user of the vehicle based on a determination that the sensor data indicates an occurrence of a thermal runaway event to cause a remedial action associated with the thermal runaway event.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100.

The example of FIG. 1A in which the vehicle 100 is implemented as a sport utility vehicle is merely illustrative. In one or more other implementations, the vehicle 100 including the battery pack 110 may be implemented as a truck (e.g., an electric pickup truck). The vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

As shown in FIG. 1B, vehicle 100 may include a support structure such as a chassis 125 (e.g., a frame, internal frame, or other support structure). The chassis 125 may support various components of the vehicle 100. As shown, the chassis 125 may span a front portion 130 (e.g., a hood or bonnet portion), center body portion 135, and a rear portion 140 (e.g., a trunk, payload, or boot portion) of the vehicle 100 in some implementations. In one or more implementations, battery pack 110 may be installed on the chassis 125 (e.g., within one or more of the front portions 130, center body portion 135, or the rear portion 140). In one or more other implementations, battery pack 110 may include or be electrically coupled with one or more one busbars (e.g., one or more current collector elements), of which may include electrically conductive material to connect or otherwise electrically couple battery module(s) 115 or the battery cell(s) 120 with other electrical components of vehicle 100 to provide electrical power to various systems or components of vehicle 100.

In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as an electric truck, another type of electric SUV, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

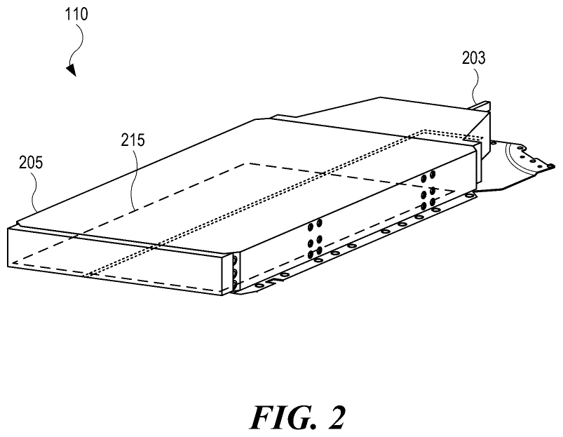

FIG. 2 depicts an example battery pack 110. Battery pack 110 may include multiple battery cells 120 (e.g., directly installed within the battery pack 110, or within batteries, battery units, and/or battery modules 115 as described herein) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, and/or multiple battery modules 115 within the battery pack frame 205 to generate a desired output voltage for the battery pack 110. The battery pack 110 may also include one or more external connection ports. As shown, the battery pack 110 may include an electrical contact 203 (e.g., a high voltage connector) by which an external load (e.g., the vehicle 100) may be electrically coupled to the battery modules and/or battery cells in the battery pack 110. For example, an electrical cable (e.g., cable/connector 106) may be connected between the electrical contact 203 and an electrical system of the vehicle 100 or a building (not shown), to provide electrical power to the vehicle 100 or the building. In some aspects, the battery pack 110 may be connected to the BMS 114 via the electrical contact 203.

As shown, the battery pack 110 may include a battery pack frame 205 (e.g., a battery pack housing or pack frame). For example, the battery pack frame 205 may house or enclose one or more battery modules 115 and/or one or more battery cells 120, and/or other battery pack components. In one or more implementations, the battery pack frame 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

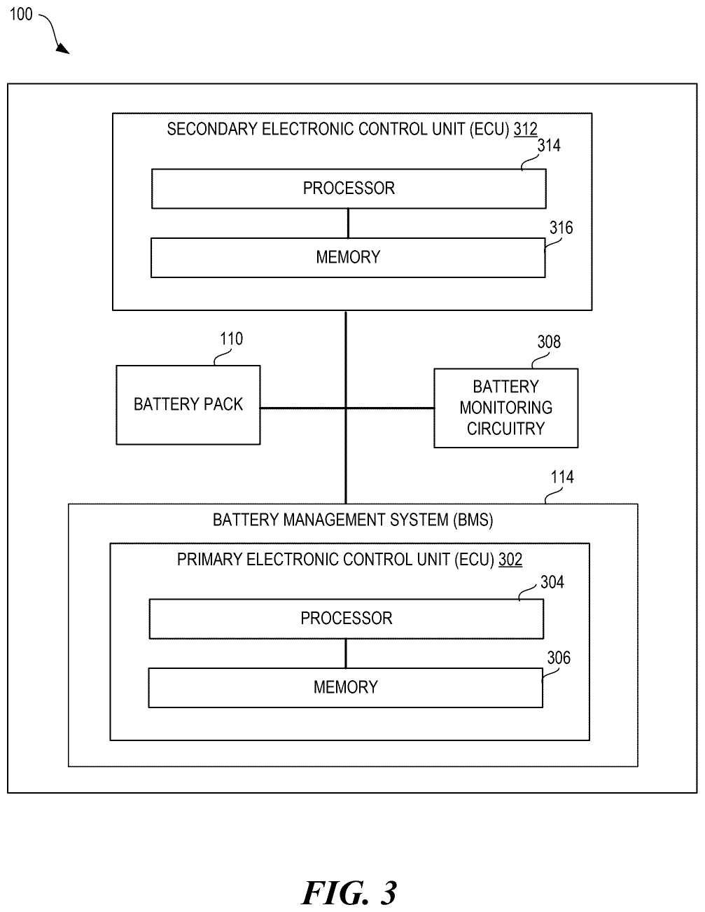

FIG. 3 illustrates a block diagram of an example vehicle 100 for thermal runaway event detection in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The vehicle 100 may include the battery pack 110, the BMS 114 and battery monitoring circuitry 308. The BMS 114 may include one or more primary electronic control units (ECUs) 302. The primary ECU 302 may include a processor 304 and a memory 306. In one or more implementations, the vehicle 100 may include a processor 304 and/or a memory 306 separate from the primary ECU 302. For example, the vehicle 100 may not include the primary ECU 302 and may include the processor 304 as a part or all of a separate semiconductor device. In one or more implementations, vehicle 100 may include multiple primary ECUs 302 that each control particular functionality of the vehicle 100.

The processor 304 may include suitable logic, circuitry, and/or code that enables processing data and/or controlling operations of the vehicle 100. In this regard, the processor 304 may be enabled to provide control signals to various other components of the vehicle 100, such as for example, the BMS 114. For example, the BMS 114 may receive a signal from the primary ECU 302 (e.g., from the processor 304 of the primary ECU 302), such as a signal to trigger open wire fault detections on the battery pack 110. The processor 304 may also control transfers of data between various portions of the vehicle 100. The processor 304 may further implement an operating system, such as a real-time operating system, or may otherwise execute code to manage operations of the vehicle 100.

The memory 306 may include suitable logic, circuitry, and/or code that enable storage of various types of information such as received data, machine learning model data, user authentication data, and/or configuration information. The memory 306 may include, for example, random access memory (RAM), read-only memory (ROM), flash, and/or magnetic storage. In one or more implementations, the memory 306 may store identifiers and/or authentication information of one or more users to determine authorized users and/or authorized authentication devices of the vehicle 100. The memory 306 may also store account information corresponding to an authorized user for exchanging information between the vehicle 100 and a remote server. The memory 306 may also store location data, including the geographic locations of historical route projections. The memory 306 may also store measurement data relating to instances of open wire fault detections performed on the battery pack 110. The memory 306 may also store battery data, including an amount of time that has elapsed since the battery was last charged.

The vehicle 100 may include one or more secondary electronic control units (ECUs) 312. The secondary ECU 312 may include a processor 314 and a memory 316. In one or more implementations, the vehicle 100 may include a processor 314 and/or a memory 316 separate from the secondary ECU 312. For example, the vehicle 100 may not include the secondary ECU 312 and may include the processor 314 as a part or all of a separate semiconductor device. In one or more implementations, vehicle 100 may include multiple secondary ECUs 312 that each control particular functionality of the vehicle 100.

The processor 314 may include suitable logic, circuitry, and/or code that enables processing data and/or controlling operations of the vehicle 100. In this regard, the processor 314 may be enabled to provide control signals to various other components of the vehicle 100, such as for example, the BMS 114. For example, the BMS 114 may receive a signal from the secondary ECU 312 (e.g., from the processor 314 of the secondary ECU 312), such as a signal to trigger open wire fault detections on the battery pack 110. The processor 314 may also control transfers of data between various portions of the vehicle 100. The processor 314 may further implement an operating system, such as a real-time operating system, or may otherwise execute code to manage operations of the vehicle 100.

The memory 316 may include suitable logic, circuitry, and/or code that enable storage of various types of information such as received data, machine learning model data, user authentication data, and/or configuration information. The memory 316 may include, for example, random access memory (RAM), read-only memory (ROM), flash, and/or magnetic storage. In one or more implementations, the memory 316 may store identifiers and/or authentication information of one or more users to determine authorized users and/or authorized authentication devices of the vehicle 100. The memory 316 may also store account information corresponding to an authorized user for exchanging information between the vehicle 100 and a remote server. The memory 316 may also store location data, including the geographic locations of historical route projections. The memory 316 may also store measurement data relating to instances of open wire fault detections performed on the battery pack 110. The memory 316 may also store battery data, including an amount of time that has elapsed since the battery was last charged.

In one or more implementations, the battery pack 110, the BMS 114, the primary ECU 302, one or more of the processor 304, the memory 306, the battery monitoring circuitry 308, the secondary ECU 312, one or more of the processor 314, the memory 316, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices), and/or a combination of both.

In one or more implementations, a thermal runaway event management system on the vehicle 100 may be configured to perform thermal runaway event detection that is structured around prevention and detection. The prevention aspect focuses on avoiding a thermal runaway event, such as a battery fire. If prevention fails, detection may be beneficial to identify thermal runaway event and notify a driver of the vehicle 100. In existing approaches, the detection and notification features may be rated as ASIL-A. In one or more implementations, ASIL-C provides some level of redundancy and testing for hardware and software, while ASIL-B offers greater safety through more extensive redundancy and testing. In one or more other implementations, ASIL-A provides the lowest level of safety integrity, and Quality Management (QM) refers to non-safety-rated designs.

For certain vehicle platforms, thermal runaway event prevention may be managed at ASIL-C, and detection relies on a user interaction. In these cases, the driver of the vehicle 100 is expected to be aware of their surroundings and able to detect smoke or fire, taking action accordingly. In one or more implementations, the thermal runaway event management system may assume the driver is actively involved in operating the vehicle 100. In one or more other implementations, the vehicle 100 may be configured with L3 autonomy, the driver of the vehicle 100 may not be aware of their surroundings or may be engaged in other activities such as reading or sleeping. In this regard, thermal runaway event management system may not rely on driver intervention. Detection and notification performed independently by thermal runaway event management system become imperative, as the driver is out of the loop. This situation can increase the safety standards, making detectability and notification safety-critical functions rated at ASIL-A(D).

Embodiments of the subject technology provide for a thermal runaway event detection system on the vehicle 100 for enhanced safety integrity in battery systems, including the battery pack 110. In one or more implementations, the combination of the detection features rated at ASIL-A(D) with the preventive features rated at ASIL-C(D) can elevate the safety integrity of the thermal runaway event management system to ASIL-D. To achieve this higher level of safety integrity, the thermal runaway event management system of the subject technology may decompose the ASIL-D rating into ASIL-C for prevention and ASIL-A for detection and notification.

In one or more implementations, independence between prevention and detection can be achieved using separate microcontrollers by having the secondary ECU 312 separate and/or independent of the primary ECU 302. The BMS 114 may be responsible for ASIL-C-rated prevention features, while the secondary ECU 312 may handle ASIL-A-rated detection and notification. This division allows the thermal runaway event management system to comply with ASIL-D standards for preventing and detecting battery fires. The BMS 114 may implement diagnostics and safety mechanisms beneficial to prevent a battery fire. If a battery fire occurs, the secondary ECU 312, separate from the primary ECU 302, can detect a thermal runaway event and generate an alert to notify the driver. This thermal runaway event management system may facilitate compliance with ASIL-D standards through specific software and hardware implementations.

In one or more implementations, the thermal runaway event management system includes the primary ECU 302, the secondary ECU 312, a sensor (not shown), and the battery monitoring circuitry 308 configured to receive sensor data from the sensor and pass the sensor data to the primary ECU 302 and the secondary ECU 312. In some implementations, the secondary ECU 312 is configured to receive the sensor data from the battery monitoring circuitry 308, determine whether the sensor data indicates an occurrence of a thermal runaway event associated with the battery pack 110 of the vehicle 100. In one or more implementations, the secondary ECU 312 detects the thermal runaway event independent of the primary ECU 302. The secondary ECU 312 can generate an alert notification to the driver of the vehicle 100 based on a determination that the sensor data indicates an occurrence of a thermal runaway event to cause a remedial action associated with the thermal runaway event.

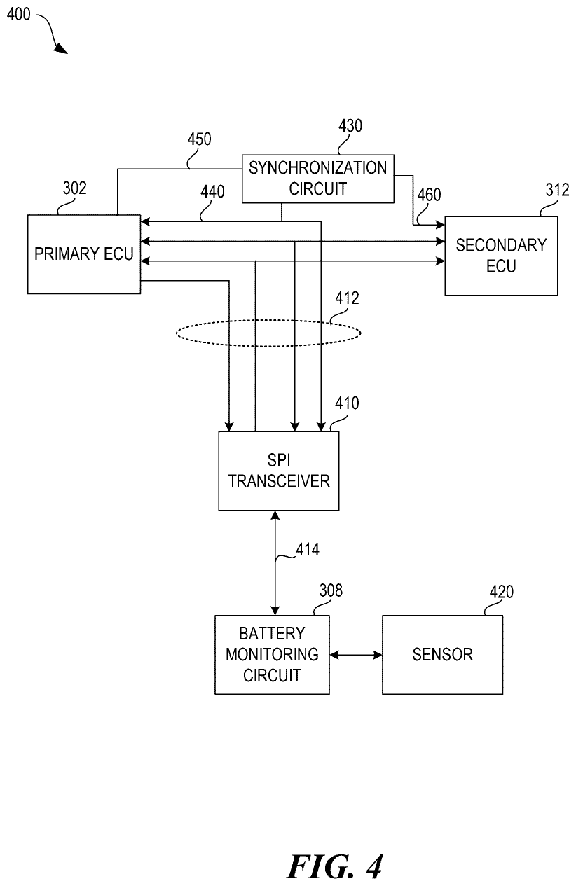

FIG. 4 illustrates a block diagram of an example thermal runaway event management system 400 in accordance with one or more implementations of the subject technology. The thermal runaway event management system 400 includes the BMS 114, which includes the ECU 302, and a secondary ECU 312 that is separate from the BMS 114. These components are connected through a SPI communication link 412, managed by an SPI transceiver 410. The SPI transceiver 410 interfaces with the battery monitoring circuitry 308 through an isolated SPI interface 414. The battery monitoring circuitry 308 is connected to a sensor 420. In one or more other implementations, the SPI communication link 412 between the sensor 420 and the primary ECU 302 includes an additional data route from the battery monitoring circuitry 308 to the secondary ECU 312 via a separate SPI communication link 412 for pressure monitoring by the secondary ECU 312. In one or more implementations, the primary ECU 302 is configured as a master device and both the secondary ECU 312 and the battery monitoring circuitry 308 are configured as slave devices in the SPI communication link 412.

In one or more other implementations, the battery monitoring circuitry 308 may be connected to multiple sensors of a same sensor type or of different sensor types. The primary ECU 302 can send command frames via the SPI communication link 412 to the battery monitoring circuitry 308. These command frames may instruct the battery monitoring circuitry 308 to collect sensor data from sensor 420 by performing a read operation with the sensor 420. The sensor data collected from the sensor 420 may include voltage, temperature, and/or pressure measurements. In one or more implementations, the sensor 420 is implemented as a pressure sensor.

In one or more implementations, the sensor 420 is integrated into the system architecture to monitor thermal runaway events. In one or more other implementations, the sensor 420 may be included irrespective of whether the thermal runaway event detection feature is rated ASIL-C or ASIL-D. In one or more implementations, the sensor 420 may be connected to the battery monitoring circuitry 308. The battery monitoring circuitry 308 may measure cell voltages and temperatures in the battery pack 110 and may monitor pressure in the battery pack 110. The sensor 420 can communicate with the battery monitoring circuitry 308 over the SPI communication link 412, where sensor data (including voltage data, temperature data, and pressure data) is sent to the primary ECU 302 and/or to the secondary ECU 312.

In one or more other implementations, the battery pack 110 may be coupled to one or multiple sensors (e.g., 420) to account for slight variations in pressure across different locations of the battery pack 110. For example, there may be three sensors coupled to the battery pack 110, one sensor coupled to each battery module 115 to monitor the battery cells 120. The sensors may measure the pressure across the battery modules 115 in the battery pack 110.

In one or more implementations, both the primary ECU 302 and the secondary ECU 312 are located on a same printed circuit board (PCB). In one or more implementations, one or more electrical traces can connect the primary ECU 302 and secondary ECU 312 on the PCB, allowing data and control signal to flow between them. In one or more implementations, the sensors responsible for monitoring parameters such as pressure, voltage, and temperature, may be positioned proximate to the battery pack 110 for optimal data collection. The sensors may be housed in separate physical packages or locations within the vehicle 100. The connection between the sensors and secondary ECU 312 can be facilitated by the SPI interface, which can be routed via a harness connecting the separate PCBs.

In one or more implementations, the secondary ECU 312 can be initialized and configured separately from the primary ECU 302. The initialization process of the secondary ECU 312 may begin when the secondary ECU 312 is powered on. The initialization process may include launching a bootloader sequence followed by launching the application that initializes all hardware components followed by the initialization of software components. After initialization, the secondary ECU 312 may start executing its logic in a manner similar to other ECUs (e.g., the primary ECU 302).

The command frames may be configured to selectively request specific types of sensor data, which are then returned in a response frame to the primary ECU 302, and to the secondary ECU 312. In one or more implementations, the secondary ECU 312 may capture only pressure data, and this data capture can be triggered by a chip select signal 460. The chip select signal 460 may be activated based on command frames that specifically request pressure data. A synchronization circuit 430, which receives input from both a chip select signal 440 generated by the primary ECU 302 and a command type signal 450 specifying the requested data type, can drive the chip select signal 460. The synchronization of these signals facilitates that the appropriate data, such as pressure information, is captured and processed by the secondary ECU 312 independently from the BMS 114 and/or the primary ECU 302. In one or more implementations, the primary ECU 302 can pass a chip select signal (e.g., chip select signal 460) to the secondary ECU 312 to synchronize the secondary ECU 312 with the primary ECU 302 based on one or more clock signals.

When the primary ECU 302 sends a command frame that instructs the sensor 420 to retrieve data, both the primary ECU 302 and the secondary ECU 312 receive the sensor data. The secondary ECU 312 may be configured to operate in a passive monitoring mode (or listen-only mode). In one or more implementations, the MISO (Master-In Slave-Out) connection in the secondary ECU 312 may be left unconnected, as the secondary ECU 312 is configured as a listen-only device. In this regard, the secondary ECU 312 can monitor sensor data on the SPI communication link 412 without sending data to the primary ECU 302.

In one or more implementations, the battery monitoring circuitry 308 can respond to the command frame with a response frame containing sensor data, in which the response frame may not include metadata indicating the requested data type. In one or more implementations, the response frame may not contain information identifying whether the sensor data corresponds to voltage, temperature, or pressure. The primary ECU 302 may pass the received sensor data directly to the secondary ECU 312 over the CAN interface without conversion into specific units (e.g., kPa).

In one or more implementations, the primary ECU 302 is configured to receive and process all the sensor data (e.g., voltage, temperature, and pressure) being transmitted in a response frame. In one or more other implementations, the secondary ECU 312 is configured to receive and process the pressure data and refrain from processing other types of sensor data (e.g., voltage, temperature) that the primary ECU 302 may process independently. The primary ECU 302 can send a command frame with a first portion (e.g., first two bytes) specifying a requested data type (e.g., temperature, voltage, or pressure), along with a packet error code (PEC) to validate the command frame. In one or more other implementations, the primary ECU 302 collects sensor data from the sensor 420 via the battery monitoring circuitry 308 by way of response frames returning sensor data in response to command frames indicating the requested data type. In one or more other implementations, the secondary ECU 312 may not determine whether the sensor data it is receiving corresponds to temperature, voltage, or pressure data without additional information.

In one or more implementations, the thermal runaway event management system 400 includes a synchronization circuit 430 coupled between the primary ECU 302 and secondary ECU 312 to synchronize the secondary ECU 312 to the primary ECU 302 using a chip select signal. For example, when the chip select signal transitions to a logical low (or “0”), the sensor data broadcast from the battery monitoring circuitry 308 is initiated. In another example, when the chip select signal transitions to a logical high (or “1”), the sensor data broadcast from the battery monitoring circuitry 308 is ceased. In one or more implementations, the synchronization circuit 430 includes a logic gate (e.g., OR gate, AND gate, XOR gate, or the like) to perform a specific logical operation depending on a desired chip select input to the secondary ECU 312. The synchronization circuit 430 may receive the chip select signal 440 and the command type signal 450 from the primary ECU 302, driving the chip select signal 460 that is driven by a combination of the chip select signal 440 and the command type signal. For example, the synchronization circuit 430 may drive the chip select signal 460 to trigger the secondary ECU 312 to process the sensor data based on the primary ECU 302 sending a command frame indicating the requested data type as pressure data. In another example, if the primary ECU 302 sends a command frame indicating the requested data type as either temperature or voltage data, the chip select signal 460 may transition to (or remain at) a logical high, causing the secondary ECU 312 to refrain from processing the sensor data. This synchronization between the sensor data and activation of the secondary ECU 312 to process the sensor data can facilitate that the secondary ECU 312 may only process the pressure data for detecting a thermal runaway event.

In one or more implementations, the desired chip select input to the secondary ECU 312 may be based on the nature of the command type signal 450 from the primary ECU 302. For example, when a voltage or temperature reading is requested, the command type signal 450 from the primary ECU 302 is assumed to be a logical high. This command type signal 450 at a logical high combined with the chip select signal 440 at a logical low can cause the chip select signal 460 to transition to a logical high at the input to the secondary ECU 312, causing the secondary ECU 312 to refrain from processing the sensor data for a duration of the chip select signal 460 being at a logical high. In the case of a pressure reading, the command type signal 450 may be at a logical low combined with the chip select signal 440 at a logical low to cause the chip select signal 460 to transition to a logical low at the input to the secondary ECU 312, causing the secondary ECU 312 to process the sensor data containing pressure data for a duration of the chip select signal 460 being at a logical low.

This configuration may allow the secondary ECU 312 to operate independent of any additional sensors or wiring. By sharing the SPI communication link 412 between the primary ECU 302 and secondary ECU 312 along with using the synchronization circuit 430 to synchronize the data flow to the secondary ECU 312, thermal runaway event management system can facilitate independent detectability and notification of battery thermal runaway events. In this regard, the primary ECU 302 can focus on prevention, while the secondary ECU 312 can process the pressure data for detection, contributing to compliance with ASIL-D safety standards.

The secondary ECU 312 can facilitate thermal runaway detection by monitoring pressure data via a CAN and/or Ethernet connection to the rest of the vehicle 100 (including with the primary ECU 302). Upon detecting a thermal runaway event, the secondary ECU 312 can send a notification to a controller in the vehicle 100 via the Ethernet connection and/or to the primary ECU 302 via a CAN communication link (not shown). This notification mechanism can facilitate display of notifications through a human machine interface (HMI) of the vehicle 100.

In one or more implementations, the secondary ECU 312 may inform the primary ECU 302 or other systems within the vehicle 100 of the detected thermal runaway event, allowing these systems to initiate (or perform) one or more remedial actions. For example, in response to detecting an occurrence of a thermal runaway event under the ASIL-A(D) safety standards, the vehicle 100 may unlock its doors, display a notification indicating a battery fire warning on a dashboard of the vehicle 100. In another example, the vehicle 100 may initiate an emergency call (e.g., a 911 call) using one or more network interfaces of the vehicle 100. In one or more implementations, the secondary ECU 312 may not engage in any direct preventive actions to stop the occurrence of the thermal runaway event (e.g., mitigate a battery fire). In one or more other implementations, the primary ECU 302 may be solely responsible for preventive measures to mitigate a battery fire's spread under the ASIL-C safety standards.

In one or more implementations, the primary ECU 302 may receive input from the secondary ECU 312 via the CAN communication link regarding the detection of a thermal runaway event based on the pressure data. The primary ECU 302 may execute one or more preventive actions in response to the received input, while the secondary ECU 312 may send outgoing signaling containing notification of the detected thermal runaway event, causing notification to the driver and/or triggering lower-level vehicle actions, such as unlocking doors.

In one or more implementations, if the primary ECU 302 fails (or ceases to operate completely), the secondary ECU 312 may detect this failure. In this scenario, the primary ECU 302 may no longer send command frames to the battery monitoring circuitry 308, resulting in no response from the battery monitoring circuitry 308. The secondary ECU 312 can identify this lack of response from the battery monitoring circuitry 308 by detecting missing heartbeats or stale data from the battery monitoring circuitry 308. In one or more other implementations, the secondary ECU 312 may employ one or more safety mechanisms that monitor the status of the primary ECU 302, providing a safeguard when the primary ECU 302 is non-functional. This configuration facilitates continued operation of the secondary ECU 312 (due to its independence from the primary ECU 302) even in the event of primary ECU 302 failure. While the secondary ECU 312 can continue to monitor the battery monitoring circuitry 308 for pressure data, the secondary ECU 312 may not actively send command frames to the battery monitoring circuitry 308 as the SPI communication link 412 between the primary ECU 302 and the battery monitoring circuitry 308 is configured for the primary ECU 302 serving as the master device. In one or more other implementations, to maintain functional safety and compliance with ASIL-D safety standards, the secondary ECU 312 may refrain from initiating pressure measurements independently of the primary ECU 302.

In one or more other implementations, the secondary ECU 312 may initiate pressure measurements using a secondary SPI communication link 412 between the secondary ECU 312 and the battery monitoring circuitry 308. In one or more implementations, the battery monitoring circuitry 308 may interface between a primary SPI communication link 412 between the primary ECU 302 and the battery monitoring circuitry 308 and the secondary SPI communication link 412, in which the primary ECU 302 may control the primary SPI communication link 412 and the secondary ECU 312 may control the secondary SPI communication link 412. In one or more implementations, in the event of a failure in the primary ECU 302, the secondary ECU 312 may transition from the primary SPI communication link 412 to the secondary SPI communication link 412 and initiate communication with the battery monitoring circuitry 308 via the secondary SPI communication link 412. This configuration may provide redundancy in the thermal runaway event management system, providing more robust detection of thermal runaway events in the event of primary ECU 302 failure.

From a functional safety perspective, this configuration may meet the safety integrity standards for independence, particularly if the primary ECU 302 fails. If the primary ECU 302 fails, the entire system relying on it would also be compromised. In one or more implementations, to meet ASIL-D safety standards compliance, one of the key standards is facilitating that the incoming data from the CAN communication link or SPI communication link 412 is protected and can be validated as uncorrupted. Implementing end-to-end data protection measures between the battery monitoring circuitry 308 and the secondary ECU 312, such as rolling counters and checksums, can facilitate the integrity of the communication and the validity of the incoming pressure data.

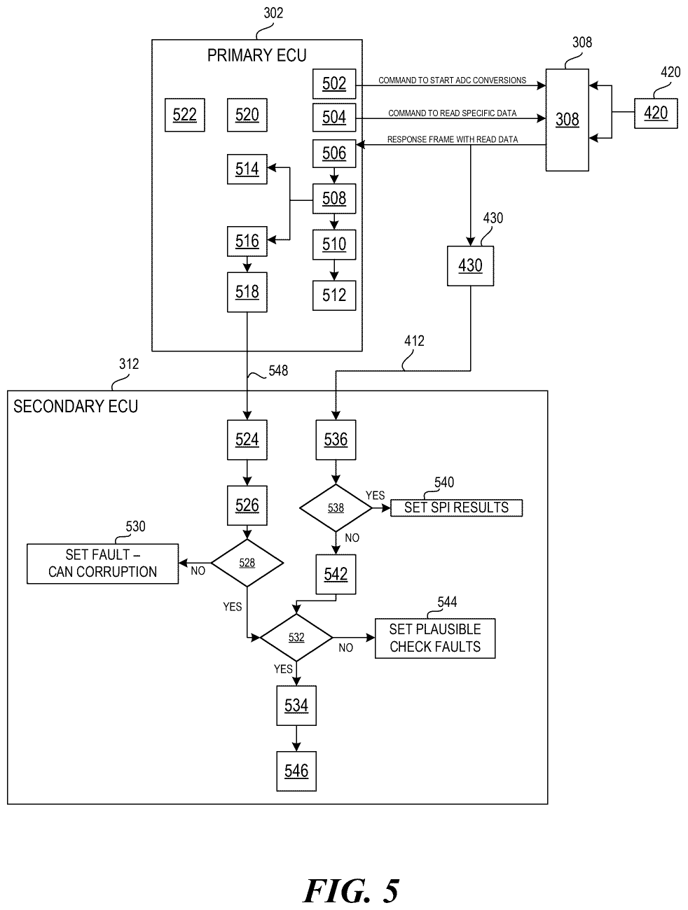

FIG. 5 illustrates a block diagram of an example system flow for thermal runaway event detection in accordance with one or more implementations of the subject technology. In one or more implementations, the thermal runaway event management system includes the BMS 114, the primary ECU 302 within the BMS 114, the secondary ECU 312, the battery monitoring circuitry 308, the sensor 420, and the synchronization circuit 430. In one or more implementations, a general-purpose input/output (GPIO) interface connects the battery monitoring circuitry 308 to the sensor 420. For explanatory purposes, the system flow is primarily described herein with reference to the vehicle 100 of FIGS. 1A-1B, and/or various components thereof. However, the system flow is not limited to the vehicle 100 of FIGS. 1A-1B, and one or more steps (or operations) of the system flow may be performed by one or more other structural components of the vehicle 100 and/or of other suitable moveable apparatuses, devices, or systems. Further, for explanatory purposes, some of the steps of the system flow are described herein as occurring in serial, or linearly. However, multiple steps of the system flow may occur in parallel. In addition, the steps of the system flow need not be performed in the order shown and/or one or more steps of the system flow need not be performed and/or can be replaced by other operations.

At step 502, the primary ECU 302 begins an initialization cycle by sending a command frame to the battery monitoring circuitry 308, instructing it to start analog-to-digital (ADC) conversions of sensor data, including pressure data from the sensor 420. At step 504, the primary ECU 302 initiates a cycle 1 process, sending another command frame to the battery monitoring circuitry 308 to read specific sensor data, such as pressure data from the sensor 420 through the GPIO interface. At step 506, the primary ECU 302 receives a response frame containing the requested sensor data from the battery monitoring circuitry 308, which includes raw sensor readings. At step 508, the process queue within the primary ECU 302 passes the received sensor data and stores the raw frame in a local array for further processing. At step 510, the primary ECU 302 executes a call route function with the stored sensor data, preparing it for further diagnostics and communication.

This initialization and data reading process (steps 502-510) can be repeated continuously for each cycle to monitor conditions of the battery pack 110 (and/or battery modules 115). Following the sensor data processing, at step 514, the primary ECU 302 performs ASIL-C diagnostics on the battery monitoring circuitry 308 to facilitate proper functionality and identify any system anomalies. At step 516, further ASIL-C diagnostics can be conducted, including verification of the cyclic redundancy check (CRC) and consistency checks of the received pressure data to verify its integrity. After validating the pressure data, at step 518, the primary ECU 302 determines the validity of the pressure data and routes it to the secondary ECU 312 via a CAN communication link 548 for independent monitoring and alerting.

In addition to data routing, the primary ECU 302 performs other ASIL-C diagnostics, such as over-temperature (OT), over-voltage (OV), and overcurrent (OC) monitoring at step 520, facilitating battery safety and stability. At step 522, the primary ECU 302 also performs system maintenance tasks such as generating heartbeat signals, triggering alarms, and maintaining watchdog timers (WDs and external WDs) to monitor overall system health. The synchronization circuit 430 facilitates that data transmissions between the primary ECU 302 and the secondary ECU 312 remain synchronized, allowing the secondary ECU 312 to monitor pressure data and other sensor readings independently of the primary ECU for detecting potential thermal runaway events.

At step 524, the secondary ECU 312 receives sensor data (e.g., pressure data) from the primary ECU 302 over the CAN communication link 548. Upon receiving the data, at step 526, the secondary ECU 312 unpacks the sensor data from the CAN communication link 548 into a local variable for processing. At step 528, the secondary ECU 312 determines if the end-to-end (E2E) protection is valid. If the E2E is valid, the process moves to step 532; otherwise, the system proceeds to step 530, where the secondary ECU 312 sets a fault indicating CAN data corruption as part of its ASIL-A diagnostics.

Concurrently, at step 536, the secondary ECU 312 receives and decodes additional sensor data from the battery monitoring circuitry 308 via the SPI communication link 412. At step 538, the secondary ECU 312 checks if the received SPI data contains any faults. If faults are detected, the system flow moves to step 540, where ASIL-A diagnostics are performed to handle the detected faults. If no faults are present, the system flow proceeds to step 542, where the secondary ECU 312 converts the SPI data into usable pressure data units.

Referring back to step 532, the secondary ECU 312 utilizes the pressure data (converted into kilopascal units) to conduct plausibility checks. In one or more implementations, these end-to-end data protection measures can include performing plausibility checks to verify the validity of sensor data. For example, the primary ECU 302 may indicate that the sensor data is valid while the secondary ECU 312 does not. In another example, both the primary ECU 302 and the secondary ECU 312 may indicate that the sensor data is invalid. If the data is found to be invalid, the system moves to step 544, where plausibility check faults are set as part of ASIL-D diagnostics. If the data passes the plausibility checks from step 532, the secondary ECU 312 proceeds to step 534 and uses the pressure data to detect any potential thermal runaway events. If a thermal runaway event is detected at step 546, the secondary ECU 312 generates an alert to notify the driver of the vehicle 100, facilitating a timely response to the thermal runaway event. In one or more implementations, these end-to-end data protection measures can facilitate compliance with ASIL-A and ASIL-C safety standards. By validating the integrity of the data through cyclic redundancy check (CRC) and other error-detection mechanisms, the thermal runaway event management system can maintain beneficial safety levels.

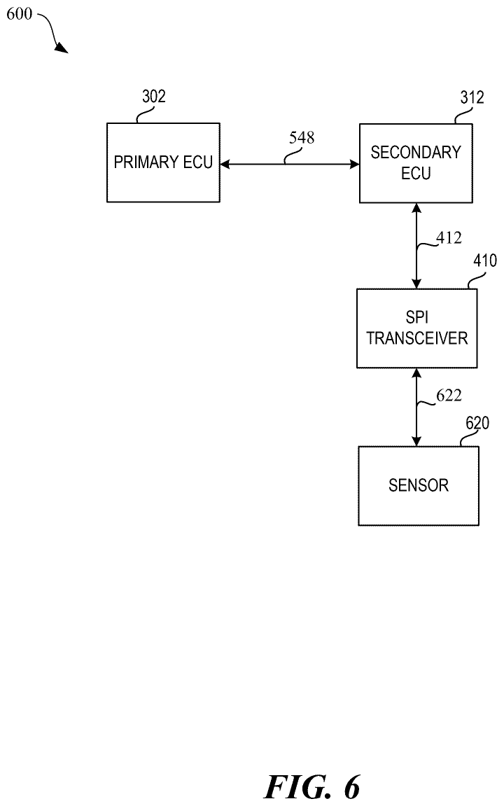

FIG. 6 illustrates a block diagram of another example thermal runaway event management system 600 in accordance with one or more implementations of the subject technology. The thermal runaway event management system 600 includes a primary ECU 302, a secondary ECU 312, an SPI transceiver 410, and a sensor 420. The sensor 420 is connected to the SPI transceiver 410 via a communication protocol 622, such as SPI or DSI3, allowing the sensor 420 to transmit its data to the SPI transceiver 410. The SPI transceiver 410 is linked to the secondary ECU 312 through a SPI communication link 412, enabling the secondary ECU 312 to receive sensor data directly from the SPI transceiver 410.

The secondary ECU 312 is also connected to the primary ECU 302 via a CAN communication link 548. In one or more implementations, the CAN communication link 548 can allow the primary ECU 302 to transmit command frames and sensor data to the secondary ECU 312 for further analysis and safety checks. The secondary ECU 312 can independently monitor and verify the sensor data, facilitating functional safety of the thermal runaway event management system 600, particularly in detecting thermal runaway events or other critical battery conditions.

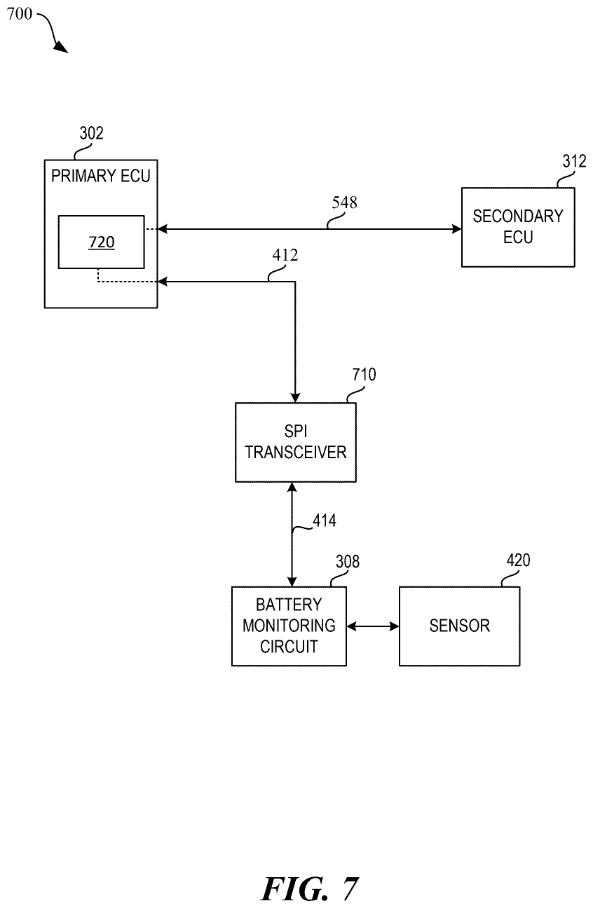

FIG. 7 illustrates a block diagram of yet another example thermal runaway event management system in accordance with one or more implementations of the subject technology. The thermal runaway event management system 600 includes a primary ECU 302, a secondary ECU 312, an SPI transceiver 410, a battery monitoring circuitry 308, and a sensor 420. The sensor 420 is connected to the battery monitoring circuitry 308 through a GPIO interface, allowing the battery monitoring circuitry 308 to gather sensor data such as pressure data. The battery monitoring circuitry 308 is connected to the SPI transceiver 410 via an isolated SPI interface 414.

The primary ECU 302, which contains an auxiliary microcontroller, is connected to the SPI transceiver 410 through a dedicated SPI communication link 412, allowing it to send commands and retrieve sensor data processed by the battery monitoring circuitry 308. The primary ECU 302 is also connected to the secondary ECU 312 via a CAN communication link 548. This CAN communication link 548 enables data exchange and coordination between the primary ECU 302 and the secondary ECU 312 for monitoring and safety checks.

The primary ECU 302 gathers sensor data from the battery monitoring circuitry 308 through the SPI transceiver 410 and performs initial diagnostics. The secondary ECU 312, which operates independently from the primary ECU, uses the pressure data from the primary ECU 302 via the CAN communication link 548 to perform additional safety checks and detect critical events such as thermal runaway.

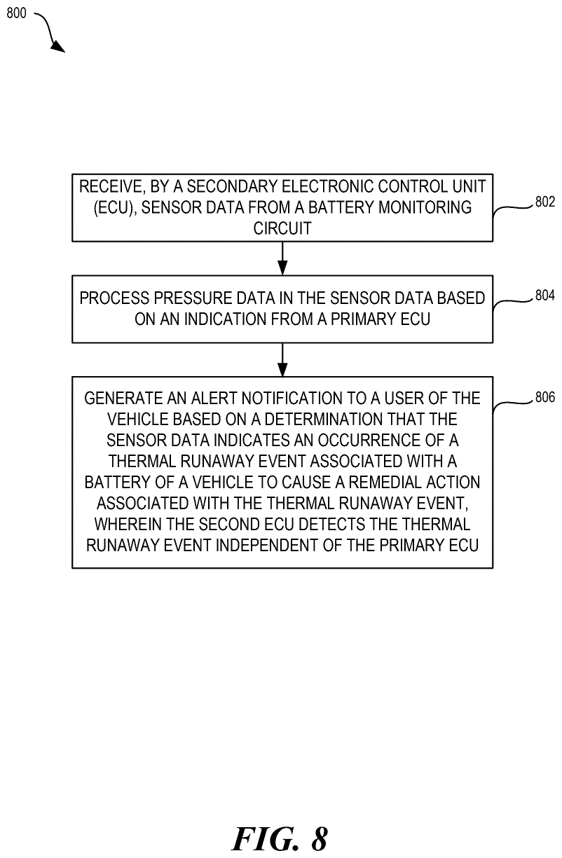

FIG. 8 illustrates a flow diagram of an example process 800 for performing open wire fault detection in accordance with one or more implementations of the subject technology. For explanatory purposes, the process 800 is primarily described herein with reference to the vehicle 100 of FIGS. 1A-1B, including the secondary ECU 312 of FIGS. 3-7 and/or various components thereof. However, the process 800 is not limited to the vehicle 100 of FIGS. 1A-1B, and one or more steps (or operations) of the process 800 may be performed by one or more other structural components of the vehicle 100 and/or of other suitable moveable apparatuses, devices, or systems. Further, for explanatory purposes, some of the steps of the process 800 are described herein as occurring in serial, or linearly. However, multiple steps of the process 800 may occur in parallel. In addition, the steps of the process 800 need not be performed in the order shown and/or one or more steps of the process 800 need not be performed and/or can be replaced by other operations.

At step 802, the secondary ECU 312 receives sensor data from the battery monitoring circuitry 308. In one or more implementations, the secondary ECU receives the sensor data from the battery monitoring circuit via a SPI communication link. In one or more other implementations, the secondary ECU receives the indication from the primary ECU via a CAN communication link.

At step 804, the secondary ECU 312 processes pressure data in the sensor data based on an indication from a first ECU (e.g., the primary ECU 302). In some examples, the indication may be an indication of a command frame type. In one or more implementations, the secondary ECU 312 can receive, from the primary ECU 302, an indication indicating whether the sensor data includes pressure data. The secondary ECU 312 can parse the pressure data from the sensor data based on the indication indicating which portion of the sensor data includes the pressure data. In one or more other implementations, the secondary ECU 312 can determine that the sensor data corresponds to pressure data based on a combination of the indication of the command frame type and a chip select signal.

At 806, the secondary ECU 312 generates an alert notification to a user of the vehicle 100 based on a determination that the sensor data indicates an occurrence of a thermal runaway event associated with the battery 110 of the vehicle 100 to cause a remedial action associated with the thermal runaway event. In one or more implementations, the secondary ECU 312 can detect the thermal runaway event independent of the primary ECU 302.

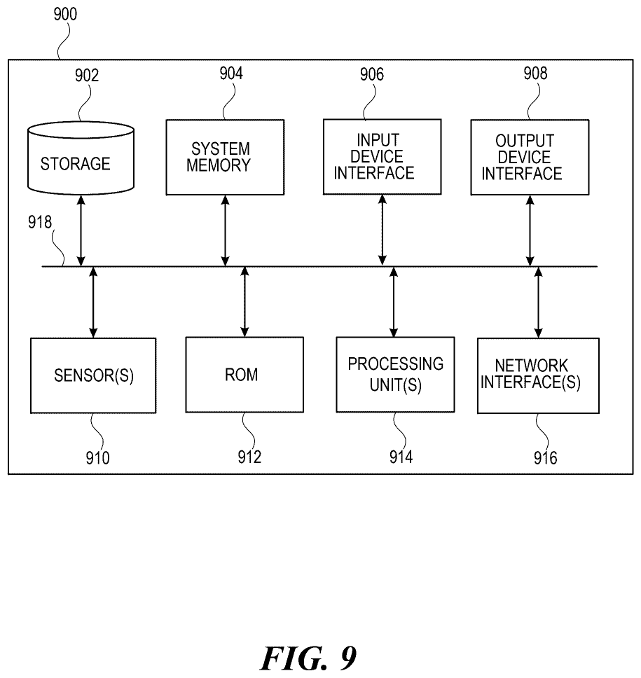

FIG. 9 illustrates an example electronic system 900 with which aspects of the present disclosure may be implemented. The electronic system 900 can be, and/or can be a part of, any electronic device for providing the features and performing processes described in reference to FIGS. 1-8, including but not limited to a vehicle, computer, server, smartphone, and wearable device. The electronic system 900 may include various types of computer-readable media and interfaces for various other types of computer-readable media. The electronic system 900 includes a persistent storage device 902, system memory 904 (and/or buffer), input device interface 906, output device interface 908, sensor(s) 910, ROM 912, processing unit(s) 914, network interface 916, bus 918, and/or subsets and variations thereof.

The bus 918 collectively represents all system, peripheral, and chipset buses that communicatively connect the numerous internal devices and/or components of the electronic system 900, such as any of the components of the vehicle 100 discussed above with respect to FIG. 4. In one or more implementations, the bus 918 communicatively connects the one or more processing unit(s) 914 with the ROM 912, the system memory 904, and the persistent storage device 902. From these various memory units, the one or more processing unit(s) 914 retrieves instructions to execute and data to process in order to execute the processes of the subject disclosure. The one or more processing unit(s) 914 can be a single processor or a multi-core processor in different implementations. In one or more implementations, one or more of the processing unit(s) 914 may be included on an ECU 204, such as in the form of the processor 206.

The ROM 912 stores static data and instructions that are needed by the one or more processing unit(s) 914 and other modules of the electronic system 900. The persistent storage device 902, on the other hand, may be a read-and-write memory device. The persistent storage device 902 may be a non-volatile memory unit that stores instructions and data even when the electronic system 900 is off. In one or more implementations, a mass-storage device (such as a magnetic or optical disk and its corresponding disk drive) may be used as the persistent storage device 902.

In one or more implementations, a removable storage device (such as a flash drive and its corresponding solid-state device) may be used as the persistent storage device 902. Like the persistent storage device 902, the system memory 904 may be a read-and-write memory device. However, unlike the persistent storage device 902, the system memory 904 may be a volatile read-and-write memory, such as RAM. The system memory 904 may store any of the instructions and data that one or more processing unit(s) 914 may need at runtime. In one or more implementations, the processes of the subject disclosure are stored in the system memory 904, the persistent storage device 902, and/or the ROM 912. From these various memory units, the one or more processing unit(s) 914 retrieves instructions to execute and data to process in order to execute the processes of one or more implementations.

The persistent storage device 902 and/or the system memory 904 may include one or more machine learning models. Machine learning models, such as those described herein, are often used to form predictions, solve problems, recognize objects in image data, and the like. For example, machine learning models described herein may be used to predict the thermal demands of a vehicle battery pack along a certain part of a route of the vehicle. Various implementations of the machine learning model are possible. For example, the machine learning model may be a deep learning network, a transformer-based model (or other attention-based models), a multi-layer perceptron or other feed-forward networks, neural networks, and the like. In various examples, machine learning models may be more adaptable as machine learning models may be improved over time by re-training the models as additional data becomes available.

The bus 918 also connects to the input device interfaces 906 and output device interfaces 908. The input device interface 906 enables a user to communicate information and select commands to the electronic system 900. Input devices that may be used with the input device interface 906 may include, for example, alphanumeric keyboards, touch screens, and pointing devices. The output device interface 908 may enable the electronic system 900 to communicate information to users. For example, the output device interface 908 may provide the display of images generated by electronic system 900. Output devices that may be used with the output device interface 908 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 918 also connects to sensor(s) 910. The sensor(s) 910 may include a location sensor, which may be used in determining device position based on positioning technology. For example, the location sensor may provide for one or more of GNSS positioning, wireless access point positioning, cellular phone signal positioning, Bluetooth signal positioning, image recognition positioning, and/or an inertial navigation system (e.g., via motion sensors such as an accelerometer and/or gyroscope). In one or more implementations, the sensor(s) 910 may be utilized to detect movement, travel, and orientation of the electronic system 900. For example, the sensor(s) may include an accelerometer, a rate gyroscope, and/or other motion-based sensor(s). The sensor(s) 910 may include one or more biometric sensors and/or image sensors for authenticating a user.

The bus 918 also couples the electronic system 900 to one or more networks and/or to one or more network nodes through the one or more network interface(s) 916. In this manner, the electronic system 900 can be a part of a network of computers (such as a local area network or a wide area network). Any or all components of the electronic system 900 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the present disclosure. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is beneficial to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different orders. Some of the steps, operations, or processes may be performed simultaneously. The accompanying method claims, if any, present elements of the various steps, operations, or processes in a sample order, and are not meant to be limited to the specific order or hierarchy presented. These may be performed in serial, linearly, in parallel, or in different order. It should be understood that the described instructions, operations, and systems can generally be integrated together in a single software/hardware product or packaged into multiple software/hardware products.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A system comprising:
a first electronic control unit (ECU);
a second ECU;
a sensor; and
a battery monitoring circuit configured to:
receive sensor data from the sensor, and
pass the sensor data to the first ECU and the second ECU,
wherein the second ECU is configured to:
receive the sensor data from the battery monitoring circuit,
determine whether the sensor data indicates an occurrence of a thermal runaway event associated with a battery of a vehicle, wherein the second ECU detects the thermal runaway event independent of the first ECU, and
generate an alert notification to a user of the vehicle based on a determination that the sensor data indicates an occurrence of a thermal runaway event to cause a remedial action associated with the thermal runaway event.

2. The system of claim 1, wherein the second ECU is further configured to:
receive, from the first ECU, an indication indicating whether the sensor data comprises pressure data, and
parse the pressure data from the sensor data based on the indication indicating which portion of the sensor data includes the pressure data.

3. The system of claim 2, wherein the first ECU is configured to send a command frame to the battery monitoring circuit to cause a read operation with the sensor to obtain the sensor data, the command frame indicating which of pressure data, voltage data or temperature data to include in a response frame to the first ECU.

4. The system of claim 3, wherein the first ECU is further configured to generate the indication based at least in part on the command frame.

5. The system of claim 1, wherein the first ECU is further configured to pass a clock signal to the second ECU to synchronize the second ECU with the first ECU based on the clock signal.

6. The system of claim 1, wherein the first ECU is further configured to send an indication of a command frame and a chip select signal to a synchronization circuit coupled between the first ECU and the second ECU, wherein the second ECU is further configured to determine that the sensor data corresponds to pressure data based on a combination of the indication of the command frame and the chip select signal.

7. The system of claim 1, wherein the second ECU receives at least a portion of the sensor data from the first ECU via a control area network (CAN) communication link.

8. The system of claim 1, wherein the second ECU receives the sensor data from the battery monitoring circuit via a serial peripheral interface (SPI) communication link.

9. A method, comprising:
receiving, by a secondary electronic control unit (ECU), sensor data from a battery monitoring circuit,
processing pressure data in the sensor data based on an indication from a primary ECU; and
generating an alert notification to a user of a vehicle based on a determination that the sensor data indicates an occurrence of a thermal runaway event associated with a battery of a vehicle to cause a remedial action associated with the thermal runaway event, wherein the second ECU detects the thermal runaway event independent of the primary ECU.

10. The method of claim 9, further comprising:
receiving, from the primary ECU, the indication indicating whether the sensor data comprises the pressure data, and
parsing the pressure data from the sensor data based on the indication indicating which portion of the sensor data includes the pressure data.

11. The method of claim 9, wherein the secondary ECU receives the indication from the primary ECU via a control area network (CAN) communication link.

12. The method of claim 9, wherein the secondary ECU receives the sensor data from the battery monitoring circuit via a serial peripheral interface (SPI) communication link.

13. A vehicle, comprising:
one or more sensors;
a primary electronic control unit (ECU);
a secondary ECU; and
a battery monitoring circuit configured to:
receive, from the primary ECU, a command frame with a request to obtain sensor data from the one or more sensors,
send, to the primary ECU, a response frame comprising sensor data in response to the command frame, and
wherein the secondary ECU is configured to:
receive the sensor data from the battery monitoring circuit and the primary ECU on different communication links,
determine that the sensor data is valid by performing one or more diagnostic checks on the sensor data,
determine that the sensor data indicates an occurrence of a thermal runaway event associated with a battery of the vehicle, wherein the secondary ECU detects the thermal runaway event independent of the primary ECU, and
generate an alert notification to a user of the vehicle to cause a remedial action associated with the thermal runaway event.

14. The vehicle of claim 13, wherein the secondary ECU is further configured to:
receive, from the primary ECU, an indication indicating whether the sensor data comprises pressure data, and
parse the pressure data from the sensor data based on the indication indicating which portion of the sensor data includes the pressure data.

15. The vehicle of claim 14, wherein the primary ECU is configured to send a command frame to the battery monitoring circuit to cause a read operation with the one or more sensors to obtain the sensor data, the command frame indicating which of pressure data, voltage data or temperature data to include in a response frame to the primary ECU.

16. The vehicle of claim 15, wherein the primary ECU is further configured to generate the indication based at least in part on the command frame.

17. The vehicle of claim 13, wherein the primary ECU is further configured to pass a clock signal to the secondary ECU to synchronize the secondary ECU with the primary ECU based on the clock signal.

18. The vehicle of claim 13, wherein the primary ECU is further configured to send an indication of a command frame and a chip select signal to a synchronization circuit coupled between the primary ECU and the secondary ECU, wherein the secondary ECU is further configured to determine that the sensor data corresponds to pressure data based on a combination of the indication of the command frame and the chip select signal.

19. The vehicle of claim 13, wherein the secondary ECU receives the indication from the primary ECU via a control area network (CAN) communication link.

20. The vehicle of claim 13, wherein the secondary ECU receives the sensor data from the battery monitoring circuit via a serial peripheral interface (SPI) communication link.
